(19) United States
(12) Patent Application Publication
(10) Pub. No.: US 2023/0087189 A1
(43) Pub. Date: Mar. 23, 2023

(54) AN AQUACULTURE FEED WITH HIGH WATER AND OIL CONTENT AND A SYSTEM AND METHOD FOR MANUFACTURING SAID AQUACULTURE FEED

(71) Applicant: GRAINTEC A/S, Vejle (DK)

(72) Inventors: Markus Wied Dethlefsen, Vejle (DK); Klaus Damsboe Holgersen, Vejle (DK); Benny Simonsen, Egtved (DK)

(73) Assignee: GRAINTEC A/S, Vejle (DK)

(21) Appl. No.: 17/801,843

(22) PCT Filed: Sep. 2, 2020
(86) PCT No.: PCT/DK2020/050243

§ 371 Date: Aug. 24, 2022

(30) Foreign Application Priority Data
Feb. 28, 2020 (DK) PCT/DK2020/050057

(51) Int. Cl. A23K 50/80; A01K 61/80; A01K 63/04; A23K 10/30; A23K 20/158; A23K 40/25

(52) U.S. Cl. CPC A23K 50/80; A01K 61/80; A01K 63/04; A23K 10/30; A23K 20/158; A23K 40/25

(57) ABSTRACT

The present invention relates to a system and a method of manufacturing a feed product for farmed animals in an aquaculture environment, including but not limited to fish, shrimps, and crabs. The method of manufacturing the aquaculture feed comprising the steps of providing and contacting water, a fatty acid component, a protein source, and a feed stabiliser, and a suspension is formed. The feed stabiliser has a setting condition represented by a setting component. The feed stabiliser is contacted with the water at an activation condition, and the concentration of the setting component in the shaped suspension is increased to the setting condition of the feed stabiliser to obtain the aquaculture feed.

### CROSS REFERENCE TO RELATED APPLICATIONS

The instant application is a U.S. National Stage application of and claims priority to PCT/DK2020/050243, filed on Sep. 2, 2020, which is a PCT application of and claims priority to PCT/DK2020/050057, filed on Feb. 28, 2020, the subject matter of both aforementioned applications are hereby incorporated by reference in their entireties.

### FIELD OF THE INVENTION

The present invention relates to a system and a method of manufacturing and preparing feed for farmed animals in an aquaculture environment, including but not limited to fish, shrimps, and crabs. The invention is especially intended to be used for manufacturing moist feed especially suitable for fish bred in an aquaculture site, e.g. Recirculated Aquaculture System (RAS) and intensive aquaculture farming systems.

### BACKGROUND

Farmed fish and shellfish are dependent on receiving all required nutrients in the feed delivered to their aquaculture site, e.g. cages out in the sea, flow-throughs in connection to a river or pond, or on-land sites such as RAS facilities. The feed must fulfil specific quality demands, both regarding nutrients (e.g. digestibility of ingredients and the overall feed conversion rate (FCR) of the feed, right concentration of essential amino acids, feed stabilisers, vitamins, minerals, oils, enzymes, and probiotic bacteria) and technical and/or physical properties (e.g. shelf life, density, size, water stability, resistance to creation of dust and/or fines, ability to agglomerate or disintegrate faeces after excretion). FCR is calculated as FIG, where F is consumption of dry matter [kg] from feed and G is the weight gain [kg] of the fed animal.

Shelf life normally refers to the microbiological stability, e.g. spoilage bacteria and fungi, and chemical stability, e.g. lipid oxidation, of the feed. The microbiological stability is primarily controlled by drying, obtaining a moisture content of 6-10% w/w in the final feed, this corresponding to a water activity below 0.62, which prevents growth of bacteria and fungi. Lipid oxidation is normally prevented or reduced by addition of antioxidants. Hereby, a feed shelf life of 6-9 months is commonly achieved. The majority of feed for farmed fish is produced by extrusion followed by drying, coating, cooling and packing. Prior to extrusion, the different raw materials and ingredients are mixed and ground to obtain a fine sized and homogenous meal mix. Right after extrusion, the moisture content is approximately 20-32% w/w and the meal is converted into a soft and porous pellet structure. Dependent on the extruder settings, the degree of expansion is controlled and adjusted to obtain a desired density and available pore volume for later additions (i.e. coatings). In the dryer, the moisture content is reduced to approximately 6-10% w/w, which helps to harden the pellet structure and improve the durability and physical quality of the feed. However, if the drying conditions are not properly controlled, the technical quality can be reduced and lead to higher levels of created dust and fines in the material handling systems following the drying process. Also, harsh drying causes high levels of pellet shrinkage resulting in increased density and reduced volume of the pores. The purpose of coating is to add liquids (e.g. oils and lecithin) and heat sensitive ingredients (e.g. vitamins, colourants, enzymes, probiotic bacteria, organic minerals, and amino acids) to the feed. Coating can either be executed by spraying, enrobing or vacuum, listed in ascendant order relative to the amount of liquid possible to add to the feed. The final density is crucial as it determines the buoyancy properties of the feed, if the feed will float or how fast it will sink. This is important as some fish species are demersal whereas other are pelagic. Consequently, expansion, shrinkage and liquid addition are important to monitor and control.

Leakage of liquids from the feed added during coating is a common quality problem and is unwanted for both RAS feed and feed for open systems, e.g. cages out in the sea or flow-throughs in connection to a river. For both types of feed, leakage constitutes a loss and results in lowered feed quality and performance, i.e. higher FCR. In addition, for RAS feed, oil leakage significantly reduces the performance of the (micro)biological filters, as they easily become covered with oil whereby their direct contact with the passing water is reduced. Consequently, oil leakage should especially for RAS feed be avoided. Furthermore, fines and dust, stresses the mechanical filters, and must likewise be avoided. For both systems, leakage, dust, and fines constitute a loss, however, open systems are—compared to RAS—less affected by low technical and/or physical feed quality, but are more sensitive to external exposure, e.g. viruses, parasites, toxic algae. As the water quality and environment can be controlled and mimicked in RAS facilities, most of these risks are eliminated, as long as the filters are working, which they will as long as the feed quality is good.

Currently, high-energy dense fish feed contains up to 45.0% w/w oil and/or fat based on the dry matter, corresponding to 41.4% w/w for the actual feed containing 8.00% moisture. This high level of fat and/or oil in the feed challenges its technical and/or physical quality; especially when fed in a RAS facility. As most of the oil for this type of high-energy dense diets is added during vacuum coating, the feed consists of two phases, which increases the risk of the oil to leak out from the feed and cause problems in the (micro)biological filters.

In nature, carnivorous fish, such as trout, salmon, and tuna, catch and eat other fish with a composition (w/w) of approximately 70-80% water, 1-10% oil, and 15-30% protein. According to WO 2015/067955A1, when farmed fish are fed dry feed containing 6-10% moisture (w/w), they have to have a water intake to maintain their natural physiological moisture content. This moisture to be added must inevitably come from the surrounding water. Consequently, in the case of fish bred in salt water, the fish have an intake of salt during feed moisturization. According to WO 2011/064538A1, the salinity in the water fraction in the fish feed must be lower than the surrounding water to allow salt water fish species to maintain the required ion balance. Consequently, in the case of feed moisturization by consumption of salt water, the fish have to physiologically return this surplus of salt to the surrounding environment. This transport process requires energy and reduces the performance of the feed corresponding to an increase in the FCR.

When fish are fed feed with the need of moisturisation, the initial moisture content of the feed is normally 6-10% w/w. Because of this, and the production process, e.g. drying, which increases the rigidity of the feed, the feed is very hard at the time of consumption. According to U.S. Pat. No. 4,935,250A and EP 2445357B1, a soft and flexible surface of the feed improves its palatability, which reduces feed losses and decrease the apparent FCR. Therefore, soft and moist feed would, from a nutritional and organoleptic perspective, be preferable. However, to obtain the desired shelf life of 6-9 months and retain the current logistic system, e.g. pneumatic transport, this is not an option. Additionally, it can be necessary to add expensive and/or low nutritional raw materials and/or ingredients to obtain said shelf life and technical/physical quality. Shelf life extending ingredients include antioxidants, e.g. ethoxyquin, BHA, BHT, which are either banned due to health risks, i.e. carcinogenicity, or listed as problematic preservatives. Low nutritional raw materials include starch and fibres, which are added to improve the technical and/or physical feed quality needed when the feed must fulfil the requirements for dry feed, e.g. physical strength allowing the feed to be packed in 1,000 kg big bags, which are stacked and transported by rumbly trucks or pneumatically/mechanically transported to the feeding site without lowering the feed quality and generating losses due to breakage or dust. In addition, these losses have an adverse impact on the operational costs, especially in RAS.

WO 2006/098629 discloses a process for producing feed for aquatic species. The process has two steps by first producing of a storage stable intermediate product followed by absorbing a gel containing water and lipids or an emulsion containing water and lipids into the pores of the intermediate product in a vacuum chamber. The gel is formed by mixing water and lipids in ratios ranging from 20-80 weight % water and 80-20 weight % lipid together with starch or gelatine. The final feed has water content below 25%.

US 2008/182005 relates to animal feed gels and discloses a method of forming an aquatic gel. The method uses a gelling agent that may be a combination of locust bean gum and carrageenan or a combination of gelatine and xanthan gum, and upon cooling form an elevated temperature, the mixture with the gelling agent is permitted to set and form a gel.

U.S. Pat. No. 3,876,803 discloses a process for preparing nonhomogeneous fish bait. In the process, a gel-forming proteinaceous material and water at a temperature above the sol-gel transition temperature are mixed to form a homogeneous liquid proteinaceous mass before cooling to form gelled shaped elements. The exterior surface on the gelled shaped elements is then cross-linked. The fish bait of U.S. Pat. No. 3,876,803 does not comprise a lipid.

US 2002/039616 discloses an animal feed gel, a preparation of the animal feed gel and a system for preparing the animal feed gel. The method the animal feed gel comprises forming a liquid animal feed at a temperature above ambient temperature and cooling the liquid animal feed such that the feed solidifies to a stiff, flexible gel.

WO 02/071867 discloses solid particulate foodstuff for aquatic life having a high moisture content. The foodstuff includes an oil-coated nutrient feed particulate embedded in a gel and an antimicrobial agent.

WO 99/12430 discloses a gelled foodstuff for aquatic animals, e.g. exotic fish, which comprises from 0.001 to 50% of a gelling agent, from 0.1 to 90% of a natural nutriment and, according to its intended use.

GB 2147181 discloses dosing of food to fish ponds where the food is shaped into the form of pellets in a press and where the pellets produced are transported by a current of water to the individual fish ponds.

### SUMMARY

It is an object of the invention to address the shortcomings of the prior art. Thus, according to a first aspect of the invention this and other objects are achieved by a method of manufacturing an aquaculture feed comprising the steps of:
providing water, a fatty acid component, a protein source, and a feed stabiliser having an activation condition and a setting condition represented by a setting component;
contacting the feed stabiliser and/or the protein source with the fatty acid component;
contacting the feed stabiliser with the water at the activation condition;
mixing the feed stabiliser, the fatty acid component, the protein source and the water to provide a suspension;
shaping the suspension into a shaped suspension; and
increasing the concentration of the setting component in the shaped suspension to the setting condition of the feed stabiliser to obtain the aquaculture feed.

The setting condition is represented by a setting component so that when a certain concentration of the setting component is reached, the conditions are changed from the activation condition to the setting condition. The concentration of the setting component corresponding to the setting condition may, in the context of the invention, be referred to as a “threshold level”. The threshold level is generally specific for the setting component, and the threshold level may be referred to as a threshold level for the setting component.

By employing activation and setting conditions different from temperatures, i.e. when there is no need to heat the feed stabiliser to activate it, and correspondingly, no need to cool the activated feed stabiliser to induce setting, the transition from the activated form to the setting conditions will generally be faster than what is possible with temperature induced setting. Thereby, a more homogeneous aquaculture feed is provided.

The method provides the mixture of the feed stabiliser, the fatty acid component, the protein source and the water as a suspension. In an embodiment, the mixture is a thick suspension that may be referred to as a dough. In another embodiment the mixture is a thin liquid-like suspension. The suspension may, regardless of its exact form be shaped so that upon exposure to the setting condition of the feed stabiliser, the aquaculture feed is obtained. For example, a liquid-like suspension may be formed into droplets, e.g. having a dimension in the range of 0.5 mm to 2 mm, e.g. about 1 mm diameter or less, which droplets can be allowed to fall into a liquid, e.g. water or an oil, providing the setting condition, i.e. a concentration of the setting component above the threshold level, e.g. an amount of calcium, potassium and/or sodium ions, and/or a specific pH representing the setting condition so that the droplets are quickly brought to the setting conditions to form the aquaculture feed. Thereby, an aquaculture feed appropriate for small marine animals, e.g. young fish, is provided. When a thin liquid-like suspension is employed, this may also include an emulsifying agent so that the suspension may be an emulsion.

The aquaculture feed manufactured by this method has a homogenous distribution of water, fatty acid component, and protein in the feed. By aquaculture feed is meant a feed for animals, preferably for farmed animals in an aquaculture environment, including but not limited to fish, shrimps, and crabs. In general, farmed animals farmed in an aquaculture environment may also be referred to as “marine animals” and the two terms may be used interchangeably. The term fatty acid component is to be understood broadly, and it can mean a triglyceride, a free fatty acid or a combination thereof. Likewise, the fatty acid component may also be a glycerol backbone with one or two fatty acid chains. The fatty acid component may have a low melting point so that it is a liquid oil at ambient temperature or it may have a melting point to be solid at ambient temperature, e.g. a fat. The fatty acid component may be a vegetable oil and or fat and/or an animal oil and or fat. Preferably the fatty acid component is a mixture of both a vegetable oil/fat and an animal oil/fat. The vegetable oil/fat may be rapeseed oil, linseed oil, sunflower oil, soybean oil and/or hardened oils like hardened palm oil or hardened rape seed oil, whereas the preferred animal oil/fat is from fish, poultry, pork, and/or beef Preferably, the mixture comprises more vegetable oils than animal oils, such as 3 parts vegetable oil to 1 part animal oil. This composition of oil has shown to be sufficient for providing a bred fish (which is rich in natural occurring oils). In particular, the fatty acid component should contain polyunsaturated fatty acids, e.g. long chained polyunsaturated fatty acids.

The aquaculture feed may appropriately be distributed in a Recirculated Aquaculture System (RAS) according to the method described in WO 2020/143890, the content of which are hereby incorporated by reference. Likewise, the feed manufacturing system of the present invention may appropriately be integrated in the RAS system of WO 2020/143890.

The feed stabiliser has a setting condition and an activation condition, and the setting condition is represented by a setting component. Any feed stabiliser that can be brought to the setting condition by a setting component may be used in the method of the invention. The feed stabiliser will typically be soluble in water, and when dissolved in water the conditions of the water determines whether the feed stabiliser is at the activation condition or the setting condition. Thus, activation of the feed stabiliser can be obtained by dissolving the feed stabiliser in water at a concentration of the setting component below the threshold level, and setting can be obtained by increasing the concentration of the setting component above the threshold level. However, the feed stabiliser may also be dispersed in the fatty acid composition, and/or the protein source, before contacting the feed stabiliser with the water at the activation condition. Once the feed stabiliser is contacted with water at the activation condition, i.e. where the concentration of the setting component is below the threshold level, whether the feed stabiliser is dissolved in water or otherwise brought into contact with water, the feed stabiliser will be active. In a specific embodiment, the feed stabiliser is dispersed in the fatty acid component. Thereby, a homogeneous mixture free from aggregates is formed. Typical setting components include alkaline metal ions, earth alkaline metal ions or other metal ions, e.g. transition metal ions, H⁺ and OH⁻, or a combination of these. The setting component may be a single component, e.g. Ca²⁺, or a combination of several components may represent the “setting component”. The setting condition will generally not involve temperature. In particular, the setting condition will not involve a change in temperature alone. However, the viscosity of the suspension will typically be temperature dependent and the temperature at the activating condition may be higher than the temperature at the setting condition.

In a specific embodiment, the feed stabiliser is dissolved in water at the activation condition prior to mixing the feed stabiliser. Since the feed stabiliser can be dissolved in water at low temperature, e.g. ambient temperature where the water is not heated, the feed stabiliser will not deteriorate due to high temperature. Thereby, large volumes of feed stabiliser dissolved in water can be stored in a condition ready for use in a method of preparation of an aquaculture feed.

The preferred group of feed stabilisers comprises polysaccharides, oligopeptides, polypeptides and mixtures of polysaccharides and oligopeptides and/or polypeptides. Oligopeptides include peptides of a length of two amino acids and up to 10 amino acids, and polypeptides include peptides with more than 10 amino acids. The feed stabiliser may also be referred to as a “hydrocolloid”. When activation and setting conditions involve a setting component, it is observed that above the threshold level, a solution, e.g. an aqueous solution, of the feed stabiliser will be a liquid, e.g. a viscous liquid, and above the threshold level, the feed stabiliser will form a semi-solid, e.g. a gel, with the solvent. In the context of the invention, the term “setting condition” means the condition, i.e. the concentration of an appropriate setting component, at which a solution of the feed stabiliser will form a semi-solid, e.g. a gel, upon increasing the concentration of the setting component above the threshold level. For carbohydrate feed stabilisers, the semi-solid form may be a gel, e.g. a “hydrocolloid gel” or “hydrogel”, when the solvent is water. In general, the viscosity of a solution of the feed stabiliser below the threshold level of the setting component will increase with increasing concentration of the setting component until the concentration reaches the activation where the viscosity drops, i.e. the threshold level. The exact activation condition may further depend on the concentration of other components, e.g. ion concentration and presence of salts other than the setting component. Application of the feed stabiliser, e.g. a gelling agent, in the method of the invention has surprisingly been found to allow that the aquaculture feed has a homogenous distribution of water, fatty acid component, and protein in the same phase, i.e. in a single phase. Thus, the invention provides an aquaculture feed having both a high water content, i.e. at least 30% w/w of the aquaculture feed, and a high oil content, i.e. at least 25% w/w, such as at least 28% w/w, of the dry matter content of the aquaculture feed contained in a single phase.

The feed stabilisers employ other conditions than temperature alone for changing to a gel form, e.g. to the “setting condition”, especially carrageenans marketed as Smart carrageenans by CP Kelco. For example, certain carbohydrates exist in aqueous solutions in a low viscous form, i.e. an “activated form”, where the addition of a setting component represents the setting condition and changes the feed stabiliser to its gel form. For example, the activation condition may be dissolving the feed stabiliser in water, e.g. at a concentration of the setting component below the threshold level, and the setting condition may involve changing the aqueous environment to the setting conditions, e.g. by increasing the concentration of the setting component, e.g. ions, such as calcium, potassium and sodium ions, and/or by increasing or lowering the pH. In specific embodiments, the setting component is contained in the protein source and/or the fatty acid component. For example, the protein source and/or the fatty acid component have a sufficient content of ions of setting component, e.g. calcium, potassium and/or sodium to provide the setting condition. Thus, in an embodiment the method comprises dissolving the feed stabiliser in water at a concentration of the setting component below the threshold level, i.e. to activate the feed stabiliser, and then mixing the water containing the feed stabiliser with a fatty acid component providing the setting component at a concentration above the threshold level and/or mixing the water containing the feed stabiliser with a protein source providing the setting component at a concentration above the threshold level. When the activation condition is mixing the feed stabiliser with water and the setting condition is mixing the aqueous solution with one or both of the protein source and the fatty acid component, it is preferred that the protein source and/or the fatty acid component is added at an increased temperature in order to ensure that activation and setting are separate steps. Increasing the temperature will furthermore decrease the viscosity and improve mixing.

A specific example of a feed stabiliser is a kappa-carrageenan marketed by CP Kelco as Smart kappa-carrageenan, which can be dissolved in water at ambient temperature. This Smart carrageenans are activated by being dissolved in water. Upon increasing the ion concentration, especially of Ca²⁺ for iota carrageenan and K⁺ for kappa carrageenan, the Smart carrageenan will form a gel, so that increasing the ion concentration is the setting condition. Manufacture of carrageenans corresponding to the Smart carrageenans is disclosed in U.S. Pat. No. 8,293,285, which is hereby incorporated by reference. The ion concentration may be increased by addition of the protein source and/or the fatty acid component, which may provide the setting condition. In this case it is preferred that the protein source and/or the fatty acid component is added at an increased temperature, e.g. in the range of 40° C. to 70° C., such as about 60° C., in order to decrease the viscosity and improve mixing. Thus, in a specific embodiment, the feed stabiliser is a Smart carrageenan, the activation condition is mixing the Smart carrageenan with water, and the setting condition is increasing the ion concentration, e.g. by adding the protein source and/or the fatty acid component. Carrageenans are described in the booklet GENU carrageenan Book, Rev. 10/05, published by CP Kelco (www.cpkelco.com). Gelling temperatures of kappa and iota carrageenans are depicted in FIGS. 1 and 2, respectively, which show how gelling, “setting”, may be induced by increasing the calcium concentration, for example by addition of the protein source and/or the fatty acid component.

In general, carbohydrate-based feed stabilisers are derived from plant material, although they may also be synthesised. Carbohydrate-based feed stabilisers extracted from plant material, e.g. for algae or seaweed, may naturally contain the setting component, and the setting component may be contained in a concentration above the threshold level. Therefore, a carbohydrate-based feed stabiliser may be isolated from a source material, e.g. a plant, such as an algae or seaweed, and the setting component removed from the feed stabiliser to provide a feed stabiliser appropriate for the method of the invention. For example, a carrageenan may be isolated from an algae and the setting component, e.g. Ca²⁺ and/or Mg²⁺ ions and/or K⁺ and/or Na⁺ ions may be removed using ion-exchange. Thus, specific carbohydrate-based feed stabilisers include carbohydrate compositions with setting components below the threshold level.

Similar considerations are relevant for gelatine. Gelatine may be activated by dissolving in water, optionally with an increase in temperature, at an appropriate pH, e.g. a pH above 8. Gelatine can exist in an aqueous solution at ambient temperature, and upon increasing the ion concentration, especially lowering the pH, i.e. changing to the setting conditions, the gelatine forms a gel. Setting of gelatine from an aqueous environment is described by Patten and Johnson, J. Biol. Chem. 1919, 38:179-190, the contents of which are hereby incorporated by reference. Thus, in an embodiment, kappa-carrageenan or gelatine, as the feed stabiliser, is dissolved in water, e.g. at ambient or increased temperature, and the feed stabiliser is mixed with the other components. Upon increasing the ion concentration, the conditions will change to the setting conditions, the feed stabiliser will form a gel to obtain the aquaculture feed. In a specific embodiment, the ion concentration is increased by addition of the dry components, e.g. the fatty acid component and/or the protein source. Apart from the relevance of temperatures, all features described for the first aspect of the invention are equally relevant for the second aspect of the invention.

Preferably, the aquaculture feed comprises 1% w/w to 15% w/w feed stabiliser of the dry weight of the aquaculture feed. More preferably the aquaculture feed comprises 2% w/w to 5% w/w or 5% w/w to 10% w/w feed stabiliser, such as 2.5% w/w or 8% w/w of the dry weight of the aquaculture feed. Preferably, the mixing, especially when contacting the water and feed stabiliser, e.g. when dissolving the feed stabiliser in water, is vigorous, such as in a high-shear mixer, to ensure that the feed stabiliser and the water are mixed without forming aggregates. When the feed stabiliser is dissolved in water, the feed stabiliser becomes hydrated. The term hydrated means in this context that water molecules are bound to/by the feed stabiliser. The feed stabiliser may be fully hydrated or partly hydrated depending on the desired water content of the aquaculture feed. Fully hydrated means that its capacity to bind water is fully utilised. The hydrated feed stabiliser will be activated when the concentration of the setting component is below the threshold level. However, the feed stabiliser may also be heated. Without being bound by theory it is believed that dissolving the feed stabiliser in water at a concentration of the setting component below the threshold level, i.e. at the activation condition, ensures better mixing of the components, e.g. the “suspension” or the “dough”, which in turns allows that a more homogeneous mixture of the water, the fatty acid component and the protein source is obtained. The fatty acid component and/or the water may also be heated prior to mixing, to obtain an increased temperature of the hydrated feed stabiliser. Preferably, the temperature is maintained at a temperature above ambient temperature, but below the boiling point of water, i.e. 100° C. at 1 atm, to reduce the evaporation of water. The activation conditions are dependent on the feed stabiliser but also the concentrations of ions other than the setting component. For protein-based feed stabilisers such as caseinates and gelatine, the activation conditions may correspond to the denaturation conditions, e.g. an increase or decrease in pH. For carbohydrate-based feed stabilisers, such as kappa-carrageenan, iota-carrageenan, alginate, pectin, and carboxymethyl cellulose (CMC), appropriate setting components are well known by a person skilled in the art. For example, the activation condition may be measured by an initial shift in particle size/swelling of the colloid during increase of the concentration of the setting component, which results in an increase in viscosity.

Any one of or all the steps prior to changing the conditions of the suspension, e.g. the dough, to the setting condition of the feed stabiliser may be carried out when the feed stabiliser is at the activation condition, e.g. below the threshold level of the setting component of the feed stabiliser. When the feed stabiliser is a Smart carrageenan, it is preferred that the protein source and/or the fatty acid component is added at an increased temperature, e.g. at or above 60° C., in order to decrease the viscosity and improve mixing. Once the water, the feed stabiliser, and the fatty acid component have properly been contacted, a homogenous emulsion/solution is formed. Additional components such as a protein source may then be mixed with the fatty acid component, water, and feed stabiliser to provide the suspension, e.g. the dough. After addition of the protein source, the composition may be a homogenous mass having a consistency like a flexible dough or like porridge, or a homogenous liquid-like suspension may be provided. When the suspension is a thick dough, the dough may then be shaped into a final shape and then brought to the setting conditions of the feed stabiliser whereby the dough thickens. Without being bound by theory, it is believed that the presence of the feed stabiliser allows that a stable aquaculture feed is provided despite the high water content in the aquaculture feed.

For protein based feed stabilisers, the setting condition is where the aquaculture feed becomes semi-solid. Carbohydrate-based feed stabilisers may form solutions of low viscosity, e.g. the feed stabilisers can be considered to naturally be in an activated form, where the temperature has little influence on the setting. For such feed stabilisers, setting may be induced by changing, especially increasing, the ion concentration. An increase of the ion concentration may be provided by adding one or both of the protein source and the fatty acid component. One method for measuring the setting condition, in particular the gelling concentration of the setting component of carbohydrate-based feed stabilisers, comprises dissolving the feed additive in water at a concentration of the setting component below the threshold level and then gradually adding the setting component and monitoring the viscosity of the solution as an effect of the concentration of the setting component. The viscosity may for example be recorded as the change, i.e. increase, in power consumption of a stirring device, e.g. a magnet stirrer. A steep increase in the viscosity will represent the threshold level of the setting component for the specific feed stabiliser.

The shape of the shaped dough may be obtained by forcing the feed composition through a die, e.g. by extrusion, to obtain objects of a fixed cross-sectional profile. A liquid-like suspension may be shaped into droplets, which can then be set by allowing the droplets to fall into a liquid with the setting component above the threshold level to provide the aquaculture feed in a pellet shape, or a liquid-like suspension of the feed stabiliser in water may be mixed with the fatty acid component and/or the protein source containing the setting component in an appropriate container, e.g. a tube, so that the mixing and the shaping are combined into a single step. Thereby, the aquaculture feed will have the shape of the container. The aquaculture feed may subsequently be further shaped as desired, e.g. an aquaculture feed formed in a tube, e.g. having a sausage-like shape, may be cut into pellets or the like. It is preferred that the fatty acid component and the protein source does not contain the setting component, and that the dough is shaped prior to adding the setting component to the dough to provide the setting condition. Preferably, the concentration of the setting component in the dough is below the threshold level of the setting component of the feed stabiliser when it enters the die.

In an embodiment, one or more steps of the method is performed at an increased temperature, e.g. a temperature at or above 55° C. In another embodiment, the method is performed at ambient temperature. In a particular embodiment, the temperature is not increased above an intermediate temperature of 55° C., 50° C., 45° C. or 40° C., at any step in the method. It is preferred that the suspension or dough is shaped at or below the intermediate temperature. The intermediate temperature is preferably in the range of 45° C. to 55° C., more preferably 45° C. to 50° C. Performing the method at ambient temperature, i.e. with no steps involving increasing the temperature, provides several advantages. In particular, the system does not require any heating and cooling, e.g. heat exchangers, boilers or the like. Heating and cooling in a manufacturing system for an aquaculture feed typically involves heat exchangers where tubes must have sufficient lengths to provide residence times to reach the required temperatures, whether high or low. Without any need to increase and decrease the temperature, the system thus does not need to be dimensioned for the corresponding fraction, e.g. especially water, to be heated to a specific temperature, and correspondingly, there is no need to dimension the system to cool down the fraction, especially water, to ambient temperature. In particular, any tubing in the system can be made much shorter. Thus, when the method of the invention is performed at ambient temperature, a system for manufacturing the aquaculture feed is greatly simplified.

A further advantage of performing the method at ambient temperature is that fouling, which typically occurs at increased temperatures, is avoided. Thereby, the need to clean a system for manufacturing the aquaculture feed is significantly reduced.

A further advantage of employing feed stabilisers that are activated independently of temperature is that large volumes, e.g. large volumes of the feed stabiliser dissolved in water, can be maintained at the activation condition with limited risk that the setting conditions are provided accidentally. Moreover, feed stabilisers requiring activation by increasing temperature generally cannot be maintained for prolonged periods of time at the activated temperature, since the stabilising strength of such feed stabilisers will deteriorate, e.g. after 24 hours or more at the required activation temperature. This advantage is especially relevant when the aquaculture feed is manufactured on site at a RAS facility, since it allows better planning of the manufacturing of the aquaculture feed, e.g. with respect to an operating schedule of the RAS facility. Thus, feed stabilisers having an activation condition and a setting condition represented by a setting component provide better process planning for on-site manufacturing of an aquaculture feed for a RAS facility.

In a preferred embodiment, the method further comprises a step of adding at least one heat-labile additive to the suspension or dough when the suspension or dough is at or below the intermediate temperature, preferably at ambient temperature. The heat-labile additive is preferably added before changing the conditions to the setting conditions to ensure an even distribution of the heat-labile additive in the dough or suspension. Since the suspension or dough is at the activated condition, it is possible to mix a heat-labile additive in the suspension or dough and simultaneously avoid degrading the heat-labile additive due to high temperatures.

A heat-labile additive is in this context an additive which is destroyed or altered by heat. Which temperature affects additives dependents on the additive, but typically starts from temperatures around 50-60° C.

The heat-labile additive may be selected from but not limited to amino acids, enzymes, colourants, flavourings, vitamins, medicine, organic minerals, antioxidants, steroids and pre-vitamins, and/or bacteria, e.g. live bacteria, such as probiotic bacteria, palatants, peptides, and their mixtures. Heat-stable additives, such as minerals, may in principle be added during any of the mixing of oil, water, feed stabiliser and/or protein. The ambient or intermediate temperature ensures that heat-labile additive is not added during too high temperatures, which may kill probiotic bacteria, degrade vitamins etc. Since the heat-labile additives can be added into the suspension or dough, there is less risk of a reduction of the additive during transportation, which is the case for dry pellets which have the heat-labile additives coated onto or impregnated into the pellet. Once the suspension or dough has been shaped into its final shape, the shaped dough may be further cooled to a temperature below the intermediate temperature.

The activation condition of the feed stabiliser and the setting condition of the feed composition generally depend on the type of feed stabiliser. However, the activation condition and in particular the setting condition may also depend on the presence, and optionally also the composition, of other ingredients and additives. Thus, the activation condition and the setting condition, i.e. the setting component, is defined for a specific feed stabiliser, and optionally the activation condition and the setting condition may be defined for a specific combination of a feed stabiliser and other ingredients, e.g. other specified ingredients at specified concentrations.

In general, the content of the feed stabiliser may be chosen freely as appropriate for the specific feed stabiliser. Certain feed stabilisers, e.g. protein and peptide based feed stabilisers, may also be nutrients and may be present in up to 70% w/w of the dry matter. Thus, for example the feed stabiliser may be selected from gelatine, and gelatine derivates, oleogels, casein, casein derivatives, and caseinates and their combinations, and these may be comprised in the aquaculture feed in the range of 20% w/w to 70% w/w, such as 25% w/w to 60% w/w, such as 28% w/w to 45% w/w, such as 32% w/w to 38% w/w of the dry matter, and the feed stabilisers will also be the protein source. For example, in an embodiment, no other protein source than the protein and peptide based feed stabilisers is present in the aquaculture feed. However, the effects of protein or peptide based feed stabilisers, e.g. the provision of a homogeneous mixture free from aggregates, will occur when the protein or peptide based feed stabiliser is present at 1% w/w to 15% w/w of the dry weight of the aquaculture feed. Thus, the content of protein and peptide based feed stabilisers may be in the range of 1% w/w to 70% w/w. When the feed stabiliser in the aquaculture feed is also the protein source, the feed stabiliser is preferably mixed with the fatty acid component before contacting the feed stabiliser with water. Thereby, a simplified manufacturing process is provided, and furthermore the protein source/feed stabiliser can be homogeneously mixed with the fatty acid component without formation of aggregates without requiring a separate feed stabiliser.

Other feed stabilisers, e.g. non-protein and non-peptide based feed stabilisers, will typically be present at up to 15% w/w of the dry content of the aquaculture feed, regardless of the chosen feed stabiliser. Exemplary feed stabilisers comprise kappa-carrageenan, alginate, iota-carrageenan, CMC, pectin, gums, e.g. xanthan gum, gum arabic, guar gum, agar and locust bean gum, ethyl cellulose, and/or lecithin, and their combinations, and the feed stabiliser may also include glycerol. Further feed stabilisers include texturised extracts from beans, seeds, including but not limited to galactomannan, such as guar gum, acacia gum, gum arabica, konjac gum, locust bean gum; fermentation derived products such as gellan gum, for instance originating from waterlilies, as well as xanthan gum. Relevant mixtures of feed stabilisers include xanthan gum and locust bean gum, in particular mixed 50:50, at which level the mixture has optimal gelling properties. Yet further feed stabilisers include methyl cellulose, hydroxypropylmethylcellulose (HPMC)/hypromellose and fibres and combinations thereof.

In an embodiment, the feed stabiliser is selected from one or more of carrageenan, alginate, agar, extracts from red and brown seaweed. Feed stabilisers derived from seaweed or algae, in particular carrageenans, alginates, agar, or their combinations, will not be metabolised by most fish eating the aquaculture feed but instead the feed stabiliser will also provide a stabilising effect in the faecal matter from the fish. Thereby, the faecal matter can be more easily separated from the water, e.g. using mechanical filters. Furthermore, feed stabilisers derived from seaweed or algae are particularly advantageous with respect to minimising oil leakage. Thus, an aquaculture feed containing a feed stabiliser derived from seaweed or algae, e.g. a carrageenan, an alginate, an agar, or their combinations, have a reduced oil leakage compared to aquaculture feeds containing other feed stabilisers.

Feed stabilisers derived from seaweed or algae function optimally at a pH about neutral, which is preferred in an aquaculture feed, so that feed stabilisers derived from seaweed or algae can provide an aquaculture feed having an approximately neutral pH, e.g. a pH in the range of 6 to 8. In contrast, feed stabilisers based on pectin function optimally at a lower pH, e.g. a pH in the range of 4 to 6. Low pH feed stabilisers are particularly useful when the aquaculture feed comprises fish silage, fish protein concentrate (FPC) or other hydrolysed ingredients. Low pH feed stabilisers, other than pectin, are well-known to the skilled person.

In a further embodiment, the feed stabiliser is selected from one or more gums, such as xanthan gum, gum arabic, guar gum, agar, and locust bean gum. In an embodiment, the feed stabiliser is selected from one or more fermentation derived products such as gellan gum (for instance originating from waterlilies), as well as xanthan gum. In an embodiment, the feed stabiliser is selected from one or more texturised extracts from beans, seeds, including but not limited to galactomannan. In an embodiment, the feed stabiliser is selected from one or more fibres.

The feed stabilisers mentioned in any of the above embodiments may constitute in the range of 2% w/w to 5% w/w of the dry weight of the aquaculture feed, e.g. the total amount of feed stabiliser. For certain feed stabilisers, the total amount may be in the range of 0.5 to 2% w/w. Where combinations of feed stabilisers are used, the ratio of the individual feed stabilisers may be chosen freely. For example, the feed stabilisers may be present in roughly equal amounts, e.g. on a weight basis, or one or more feed stabilisers may be present in larger amounts relative to other feed stabilisers, e.g. the aquaculture feed may consist of 2% carrageenan, 1% alginate, and 0.5% agar.

The aquaculture feed is eventually allowed to cool to ambient temperature. After or during setting, e.g. cooling to ambient temperature, the aquaculture feed may be allowed to harden, The hardening may occur as a consequence of the moisture content, and for example the moisture content may be reduced to 4% w/w to 12% w/w, e.g. 6% w/w to 10% w/w, by drying, and thereby the hardening will improve the structure and the durability and physical quality of the aquaculture feed, in particular when the aquaculture feed is in pellet form.

The presence of the feed stabiliser in combination with a high water content allows a structured aquaculture feed to be manufactured without the requirement for fillers, such as starch or fibres to provide structure. The aquaculture feed manufactured according to the invention comprises no or a very small content of starch. It is preferred that no filler, in particular no starch, is used in the manufacturing of the aquaculture feed, although the ingredients may contain starch as an unavoidable impurity. However, it is also contemplated that a small amount of starch is used in the manufacturing of the aquaculture feed as a prebiotic, e.g. at 5% w/w or less, e.g. 2% w/w or 1% w/w or less, of the dry weight of the composition. Thus, in an embodiment starch is not added in any steps of the method. Most fish cannot effectively digest starch, and it is therefore considered a filler with little nutritional value. It is normally used to create a good structure in pellets. Preferably, the aquaculture feed comprises on dry matter basis less than 15% w/w of starch, such as less than 10% w/w of starch, or less than 5% w/w of starch, e.g. less than 1% w/w starch. By manufacturing an aquaculture feed with little or no starch, the content of nutrients in the feed on a dry matter basis is increased compared to dry pellets. The aquaculture feed manufactured according to the invention comprises a high water content and a high oil/fat content. The aquaculture feed therefore resembles the composition of natural prey of carnivorous fish much better compared to dry pellets. Additionally, since the manufactured aquaculture feed is a moist feed, no drying step is required in the manufacturing process. It is therefore possible to manufacture the feed at the aquaculture site without creating any major nuisance, which typically arises in aquaculture feed production, especially from drying. By the term aquaculture site is meant a facility for breeding fish such as a RAS-facility.

In a preferred embodiment of the invention, the odour which is formed by the manufacturing of the aquaculture feed is less than 215,000 OU_{E}/kg feed dry matter (European Odour Units/kg), more preferably less than 150,000 OU_{E}/kg feed dry matter, most preferably less than 100,000 OU_{E}/kg feed dry matter. Preferably, this low emission is obtained even without cleaning exhaust air with biofilters or ozone chambers which would increase the CAPEX and OPEX of the manufacturing process.

By manufacturing the aquaculture feed at or near the aquaculture site, it is possible to manufacture the feed when it is needed, i.e. when fish are to be fed. It is therefore possible to avoid addition of shelf life extending additives which do not provide any or only little nutritional value, since the aquaculture feed can be freshly consumed. Additionally, the raw products for manufacturing aquaculture feed often has a shelf life much longer than the actual feed. The raw products, e.g. oil, water, protein, feed stabiliser etc., can therefore easily be stored at the aquaculture site.

In a preferred embodiment of the invention, the suspension is in the form of a dough, and the method further comprising the step of adding gas to the dough. By adding a gas into the dough, small cavities of gas are obtained. The presence of the feed stabiliser allows that the small cavities of gas are substantially isolated from the surroundings. Thereby, the amount of gas inside the dough may be used to lower the density of the final aquaculture feed so that the aquaculture feed can be designed to float on water or sink to the bottom, or the density of the aquaculture feed may be close to that of the water, e.g. due to the content of salt, so that the aquaculture feed will remain in the water without sinking. This step may e.g. be carried out in a mixer or kneader where a gas such as air is provided through an air inlet into the dough or by whipping air into the dough. Other gas compositions than air may be used, such as gasses selected from the group consisting of nitrogen (N₂), CO₂, O₂ and N₂O, and combinations thereof. For example, the gas may be more oxygen or nitrogen rich gas or even substantially pure oxygen or substantially pure nitrogen (N₂). In the context of the invention, the term “substantially pure” means that the gas only contains unavoidable impurities. Alternatively, the addition of gas into the dough may be achieved by having a formation of gas in the dough. This may be achieved by adding a gas formation ingredient such as baking soda. Pure nitrogen advantageously stabilises unsaturated fatty acids, in particular poly-unsaturated fatty acids, from oxidation. Thereby, the method of the invention allows manufacture of an aquaculture feed comprising unsaturated fatty acids, which are stabilised so that the aquaculture feed can be stored, e.g. for at least 1 month, before feeding to marine animals.

The small cavities are substantially isolated from the surroundings, i.e. they do not form a porous structure. In the context of the invention, the term “porous” means that a structure has pores in the surface, and consequently the term “non-porous” means that the surface, i.e. the surface of the aquaculture feed of the invention, does not have pores. It is preferred that the aquaculture feed, e.g. in the form of pellets, has a non-porous surface. However, gas may be added to the dough to create cavities in the aquaculture feed, e.g. to control the density of the aquaculture feed. Cavities are substantially isolated from the surroundings, and when the term “porosity” is used to describe the cavities this does not imply that the aquaculture feed has porous surface. The non-porous surface has the effect that when the pellet is added to water, the water cannot enter the cavities. A pellet manufactured by this method may therefore have a total porosity of 5 to 50%, whereas the effective porosity of the feed (how many of the cavities are connected to the surroundings) is less than 5%, preferably 0% to 2%. In the context of the invention, the porosity is a percentage of the total volume of the aquaculture feed, i.e. vol %, also when this is not explicit.

Some fish species are known for spitting out feed which do not have a palatable taste. In a preferred embodiment of the invention, the method therefore further comprises the step of adding one or more attractants to the aquaculture feed. Likewise, a palatant may also be added. When an attractant and/or a palantant is added at an intermediate temperature, the method allows that heat sensitive attractants and/or palantants can be included in the aquaculture feed of the invention. Preferably, the one or more attractants are added after the intermediate cooling step, such as before or during the shaping step. Some fish like salmon, eat aquaculture feed in one bite without disintegrating the feed. For these types of fish, it is sufficient to have the attractant located substantially on the surface of the feed or in the outer layer of the feed. An attractant located on the feed or in the outer layers of the feed provides a taste to the aquaculture feed which is palatable to the fish.

Other farmed animals such as shrimps of craps eat the aquaculture feed in small bites. An aquaculture feed for feeding such animals, may have the attractant distributed through the aquaculture feed such that the entire aquaculture feed has a palatable taste. Attractants preferably originates from the marine environment and may be fish meal or fish oils such as krill extracts, krill hydrolysate, free fatty acids, and/or trimethylamine or similar compounds such as TMAO or amines.

In a preferred embodiment of the invention, the steps of shaping the dough are performed by passing the dough through a pipe where the setting component is added. To ensure proper mixing of the components of the aquaculture feed, the pipe may have a length of several meters, such as 1 meter to 5 meters.

In the step of changing the dough to the setting condition of the feed stabiliser, the aquaculture feed is obtained. The aquaculture feed may be obtained in any shape as desired, and the method may involve any procedure to further shape the aquaculture feed. For example, the aquaculture feed may be obtained in the form having a low specific surface area, e.g. a “block”, for subsequent subdivision into smaller sizes, e.g. “pellets”, appropriate for feeding marine animals. A low specific surface area minimises evaporation and also minimises access of oxygen in the surrounding air so that unsaturated fatty acids, especially poly-unsaturated fatty acids, in the aquaculture feed are stabilised. Minimising evaporation is especially advantageous due to the high water content of the aquaculture feed. Thereby, the method of the invention provides an aquaculture feed with high water and oil contents, which can be stored, e.g. for at least 1 month, before feeding to marine animals.

As an example of an aquaculture feed with a low specific surface area, the dough or a liquid-like suspension may be passed through a pipe, in particular a cooled pipe, so that the aquaculture feed is obtained in a generally cylindrical shape, e.g. a “sausage shape”. The cylindrical shape may then be cut into smaller pieces, e.g. “pellets” before distributing the feed.

A cutter may be mounted near one end of the pipe, to divide the feed into pieces of a suitable size. Pieces of feed is preferred for easier distribution of the feed. The aquaculture feed of the invention may be in the shape of pellets, e.g. pellets provided by cutting the feed in the cutter.

After manufacturing of the aquaculture feed, feed residues and/or fatty acid components may be located on the surface of the aquaculture feed. This is not preferred in a RAS-facility where any residues will end up in the water treatment unit of the RAS-facility.

In a preferred embodiment of the invention, the method further comprises the step of washing the aquaculture feed, preferably in water, to obtain a washed aquaculture feed and a residue portion, said residue portion comprising surface oils i.e. the fatty acid components, and/or loose dough material. In a preferred embodiment of the invention, the method further comprises the step of separating the aquaculture feed, preferably by sieving means, in a first fraction comprising the washed aquaculture feed and a second fraction comprising the residue portion. By washing the feed, no or limited components of the residue fraction is added to the fish holding unit together with the aquaculture feed and it therefore ensures that no or only a limited residue fraction enters the mechanical and/or (micro)biological filters in the water treatment unit of the RAS-facility. A water treatment unit for a RAS-facility utilizing aquaculture feed of the invention and/or aquaculture feed manufactured by the method according to the invention, can therefore be dimensioned smaller than water treatment facilities for RAS-facilities utilizing traditional dry pellet feed. The manufacturing method can thereby easily be implemented to existing RAS-facilities, since it does not require any upgrade of the existing water treatment unit.

The aquaculture feed manufactured according to the invention resembles the appearance and consistency of marzipan or mozzarella, and is therefore not well suited for mechanical or pneumatic transporting.

In a preferred embodiment of the invention, the aquaculture feed is added to a flowing water stream whereby the aquaculture feed is hydraulically transported.

Existing RAS-facilities comprise one or more fish holding units and one or more water treatment units. The fish holding units may comprise a circumferential wall defining an interior volume suitable for accommodating water and fish. The water stream has a flow of water fluidly connected to the one of more fish holding units. The flow of water flows in a direction from where the feed is manufactured towards the fish holding unit. When the aquaculture feed is added to the water stream it is thereby hydraulically transported to the fish holding unit. Preferably, the water stream comprises recycled water, i.e. water which have been used for breeding fish in the RAS-facility and which preferably has been treated in the water treatment unit. Preferably, 90 volume % or more of the water in the water stream is recycled water, such as 95 volume % or more.

In a preferred embodiment of the invention, the separated residue portion is recirculated and mixed with the feed stabiliser, fatty acid component, e.g. oil, protein source, and the water to provide a dough. The feed residues and oils may then be used in the manufacturing of aquaculture feed. The feed residues may optionally be separated from the water and/or oil before being added to the manufacturing process. The separation of feed residues may be carried out by solid-liquid separation means such as sieving means, a centrifuge, decantation means or extraction means. The fatty acid component comprised in the residue portion may optionally be separated from the water and/or feed residues before being added to the manufacturing process. The separation of oil may be carried out by separation means utilizing difference in density such as a centrifuge, a hydro-cyclone and/or settling tank.

By adding the components of the residue portion individually to the feed composition allows for a more precise dosing, but preferably all components in the residue portion are recycled to minimise or even eliminate any waste. Preferably, a separated solid feed residue fraction may be mixed with the protein source and added together with it, a separated liquid oil fraction may be mixed with the fatty acid component and added together with it, whereas a separated liquid water fraction may be mixed with the water and/or contacted with the feed stabiliser.

In another aspect, the invention relates to an aquaculture feed comprising a protein, a feed stabiliser, water and a fatty acid component with the fatty acid and the water being comprised in the same phase, wherein the feed on a dry matter basis comprises 28% w/w or more of the fatty acid component, and wherein the content of water is at least 30% w/w of the aquaculture feed. The feed may on a dry matter basis comprises 28% w/w or more, preferably 35% w/w or more, more preferably 45% w/w or more, preferably 50% w/w or more, more preferably 55% w/w or more, more preferably 60% w/w or more, most preferably around 70% w/w of the fatty acid component. The feed may have a content of water that is at least 30% w/w of the aquaculture feed.

The aquaculture feed may have any form as desired, but regardless of the form, the aquaculture feed will have a surface. Before being fed to a marine animal, e.g. a fish, the aquaculture feed will typically be in a form appropriate to be eaten by the marine animal. For example, the aquaculture feed may be provided as a mass to be comminuted to smaller particles, e.g. pellets. Thus, the aquaculture feed may be pellets, e.g. having dimensions in the range of 0.5 mm to 10 mm or more, or the aquaculture feed may be in the form of a sausage or the like for easy comminution to pellets or the like. Regardless of the form, the aquaculture feed preferably has a non-porous surface.

Preferably, the aquaculture feed is a homogenous mass, e.g. without aggregates in the mixture of the fatty acid component and the feed stabiliser, meaning that the water and fatty acid component, e.g. oil, is comprised in the same phase bound together by the protein and feed stabiliser. Since the fatty acid component is bound in the homogenous mass (and not in the pores of a dry pellet), there is no risk of oil leak from the aquaculture feed if the feed is divided into pieces. Additionally, the homogenous mass reduces the risk of fat belching and thereby increases the fish's intake of oil. Fat belching is known from dry pellets where the pellet disintegrates in gastrointestinal tract, such as the gut or the stomach of the fish, and the fatty acid component leaks out of the pellet and settles in the top of the gut or stomach while water and pellet matter settles on the bottom. If the fish has abdominal contractions, the fish typically throw-up the fatty acid component settled in the top.

The protein source may be in the form of a slurry such as fish silage or a whey composition, e.g. a by-product from manufacture of cheese. The protein source may also be added in the form of a protein powder such as, but is not limited to fish meal, soy protein, egg white protein, casein, blood meal (haemoglobin meal), insect meal, legume and grain based protein, and/or gluten.

Some proteins, such as casein, may have emulsifying and thickening properties. Use of such proteins may reduce the amount of feed stabiliser required in the aquaculture feed, or even replace the feed stabiliser. Additionally, casein comprises high amounts of essential amino acids beneficial to fish. The aquaculture feed preferably comprises 20% w/w to 70% w/w, such as 25% w/w to 60% w/w, such as 28% w/w to 45% w/w, such as 32% w/w to 38% w/w of a protein source on a dry matter basis.

In a preferred embodiment the aquaculture feed comprises 28% w/w to 70% w/w of fatty acid component, more preferably 30% w/w to 65% w/w, more preferably 35% w/w to 45% w/w, more preferably 38% w/w to 42% w/w such as 40% w/w fatty acid component measured on dry matter basis. A fat sealer may be added together with the fatty acid component to increase the viscosity/melting point of the fatty acid component. The aquaculture feed preferably comprises an additive, such as a heat-labile additive, in amounts of 0% w/w to 10% w/w, such as 1% w/w to 8% w/w, such as 2% w/w to 6% w/w, such as 5% w/w of the dry weight of the aquaculture feed.

The water content of the aquaculture feed may be at least 30% w/w, and up to around 75% w/w to 80% w/w, which is the natural water content in the prey of carnivorous fish. Preferably, the aquaculture feed has a water content of around 35% w/w to 50% w/w, such as 45 to 55% w/w. A water content in the range of 30% w/w to 80% w/w ensures that the pellet is moist and that the chemical potential of the feed to absorb any water is lowered. Hence, when the aquaculture feed is added into water, the uptake of water is very limited. This is especially beneficial for fish bred in salt water, since a large intake of salt water may negatively influence the salt balance of the fish. By reducing the salt water flow into the feed, it is much easier to control the salt intake of the fish eating the aquaculture feed.

The consistency of the moist aquaculture feed is similar to the one of mozzarella or marzipan. This ensures that the aquaculture feed is elastic. This reduces the risk of disintegration during e.g. hydraulic transport. Typically, the aquaculture feed may deform but not split during a compression test of 20 N to 150 N, which correspond to a deformation of around 0.15 mm to 0.50 mm for a dry aquaculture feed having a thickness of 10 mm.

In a preferred embodiment of the invention, the feed stabiliser is selected from the list consisting of kappa-carrageenan, alginate, iota-carrageenan, CMC, pectin, gums, gelatine, oleogels, caseinates, ethyl cellulose and/or lecithin, and wherein content of the feed stabiliser is between 1% w/w to 15% w/w such as 2% w/w to 8% w/w, preferably around 2.5% w/w or 4% w/w of the dry weight of the aquaculture feed. The feed stabilisers may be considered to be additives which have gelling, thickening, emulsifying, and/or humectant properties. Alginate and carrageenan and other feed stabilisers may be preferred due to their maritime origin. Some feed stabilisers, such as lecithin, may provide additional nutrients or improved digestibility of the aquaculture feed. In a preferred embodiment, the, aquaculture feed comprises 1% w/w to 10% w/w feed stabiliser of the dry weight of the aquaculture feed, such as 1% w/w, 2% w/w, 3% w/w, 4% w/w, 5% w/w, 6% w/w, 7% w/w, 8% w/w or 9% w/w of the dry weight of the aquaculture feed. This amount of feed stabiliser has shown sufficient for providing an even stabilisation of fatty acid component, e.g. oil, water, and protein in the aquaculture feed.

Tap water is typically used to manufacture the aquaculture feed, but additional salts may be added to provide an aquaculture feed having the optimal salt balance for the fish. It is important that the aquaculture feed is stable, such that no or very little water is absorbed into the aquaculture feed if it is added into e.g. salt water of a fish holding unit.

In a preferred embodiment of the invention, the feed has a water uptake of less than 30 g water per 100 g feed when soaked in water for 10 minutes. Preferably, the feed has a water uptake of less than 20 g water per 100 g feed, such as 10 g water per 100 g feed, such as 5 g water per 100 g feed, such as less than 3 g water per 100 g feed, such as 2 g water per 100 g feed, such a 1 g water per 100 g feed when soaked in water for 10 minutes.

The low uptake of water ensures that salt water fish that eats the aquaculture feed do not have a too high salt uptake, which reduce the weight gain of the fish per consumed feed.

The aquaculture feed may have a density above or below or equal to the density of seawater and/or fresh water. This is beneficial since some fish prefer to eat feed which floats in the water surface, some prefer feed that sinks through the water, while some prefer feed which is at or near the bottom. An aquaculture feed which is adapted to water type and fish type is therefore preferred. In a preferred embodiment of the invention, the density of the aquaculture feed is in the range of 800 kg/m³ to 1200 kg/m³, such as 800 kg/m³ to 1000 kg/m³, or such as 1000 kg/m³ to 1200 m³. The density of the aquaculture feed is the result of the densities of the ingredients added to the aquaculture feed, but may be controlled by adjusting the amount and size of cavities of gas inside the aquaculture feed. A low density aquaculture feed, i.e. with a density below 1000 kg/m³ has a higher volume of cavities relative to the volume of the feed, compared to a high density aquaculture feed, i.e. with a density above 1000 kg/m³.

The cavities in the aquaculture feed are connected to each other in a much lesser extent than typical dry pellets. Similarly, the cavities in the aquaculture feed are isolated from the surroundings, such that liquids, e.g. water, cannot impregnate the feed. The cavities are obtained by trapping gas inside the dough during manufacturing. In a low density aquaculture feed, the cavities may occupy up to 50% of the volume of the aquaculture feed, i.e. the aquaculture feed may have a total porosity of up to 50%. In a high density aquaculture feed the, cavities may occupy as little as 5% or even 0% of the volume of the aquaculture feed, i.e. the total porosity may be down to 5% or even 0%.

In a preferred embodiment of the invention, the aquaculture feed has a total porosity of 1% to 50%, more preferably 10% to 40%, most preferably 20% to 30%, wherein the effective porosity of the feed is around 0% to 5% independently of the total porosity. The effective porosity is the % of cavities in the aquaculture feed which are connected to the surroundings. An aquaculture feed having a total porosity of 45% and a density lower than 1000 kg/m³ may have an effective porosity of less than 5% such as e.g. 1%. Only 1% of the cavities may therefore be impregnated by water when soaked in water. In this context, impregnate means that liquid from the surroundings flows or diffuses into the feed and fills the cavities of the feed, whereby the liquid content of the feed increases.

In another aspect, the invention relates to a feed manufacturing system for producing an aquaculture feed according to the method of the invention. The feed manufacturing system may be adapted for being coupled to a recirculation conduit of a recirculating aquaculture system (RAS) and arranged such that the aquaculture feed manufactured in the feed manufacturing system is allowed to enter the recirculation conduit, said feed manufacturing system comprising:
a storage tank for storing an aqueous solution of feed stabiliser having an activation condition and a setting condition represented by a setting component, the storage tank being in fluid communication with a mixing chamber;
the mixing chamber comprising mixing means, the mixing chamber being provided with at least one inlet allowing entry of powder and liquid raw materials into the mixing chamber the mixing chamber having an outlet allowing a feed mixture to exit the mixing chamber,
a shaping arrangement fluidly connected to and located adjacent the outlet of the mixing chamber, the shaping arrangement comprising a flow channel configured to shape the feed mixture flowing through the flow channel, and the shaping arrangement optionally comprises cooling means for cooling a feed mixture flowing through the flow channel.

By employing a storage tank for storing an aqueous solution of feed stabiliser having an activation condition and a setting condition represented by a setting component, a feed manufacturing system is provided, which allows better planning of the manufacturing of the aquaculture feed for a RAS facility.

In a preferred embodiment, the feed manufacturing system does not comprise a heat exchanger. In other embodiments, the feed manufacturing system does not comprise means for heating and cooling.

In yet a further aspect, the invention relates to a recirculating water aquaculture system having the feed manufacturing system.

When the feed manufacturing system is incorporated into the RAS-facility, the logistics for handling the aquaculture feed is simplified. It also provides the possibility of reducing or even eliminating the use of preservatives in the aquaculture feed, since it becomes possible to provide freshly made aquaculture feed to the fish. By reducing the use of preservatives and other ingredients for enhancing shelf life, impregnating pellets etc., a more economical pellet can be manufactured. Simultaneously, the amounts of nutrients relative to the dry weight of the feed increases due to the reduction or elimination of these ingredients. Additionally, since no drying and coating are required in the aquaculture feed manufacturing system, the operating expenses (OPEX) are much lower compared to a regular aquaculture pellet manufacturing system. Other advantages by avoiding a dryer is reduced nuisance which eliminated the need of a high chimney (reduced CAPEX) while process contaminants such as heat damaged nutrients, e.g. burned proteins, also are avoided.

The water treatment unit is used to treat water in the RAS-facility so that used water from the fish holding unit can be treated and recycled back to the fish holding unit. The water treatment unit may comprise a series of treatment processes to maintain water quality such as, but not limited to, bio-filtration, removing of solids, e.g. filtration, oxygenation, pH control, temperature control, optionally including heating and/or cooling, Ultra Violet (UV) treatment and/or ozone treatment.

The water recirculation conduit is a series of water conduits or water pipes suitable for transporting the water to/from the fish holding unit. The recirculation conduit is fluidly connected to the fish holding unit and forms a water circuit. The recirculation conduit is connected to the fish holding unit through at least one aperture allowing for an intake and/or outlet of water. Preferably, the water pipes in the recirculation conduit are used to remove water continuously or intermittently from the fish holding unit. The recirculation conduit may comprise one or more unit operations which the water passes through, where after the water is returned to the fish holding unit, i.e. the recirculation conduit recirculating the water. The unit operations may e.g. be means for treating the water or means for loading feed into the conduit.

The feed manufacturing system provides the means for enabling the manufacturing of fresh aquaculture feed from raw components such as protein, water, fatty acid component and a feed stabiliser. Additional nutrients may also be comprised in the aquaculture feed. Mixing means may be in the form of an agitator, kneader, or other rotatable blades.

After the feed is shaped in the shaping arrangement, the shaped feed drops/falls into the water in the water bath where it sets.

The feed manufacturing system of the recirculating aquaculture system may further comprise a washing arrangement comprising a washing chamber being configured to allow entry of an aquaculture feed from the shaping arrangement and for containing a washing liquid; a liquid driving force for providing movement of the washing liquid to wash the aquaculture feed, and a transport arrangement configured to remove the aquaculture feed from the washing chamber, draining the washing liquid from the aquaculture feed and delivering the aquaculture feed to the water recirculation conduit. The washing liquid is preferably water, or an aqueous solution comprising salts.

The liquid driving force may be a slide on which the aquaculture feed is slid down into water, or a slowly rotating mixer, which creates some flow in the water.

The transport arrangement may be one or more conveyers, wherein the aquaculture feed is transported on a grid, mesh, or belt which allows water to be drained from the aquaculture feed and remain in the washing chamber.

In a preferred embodiment, the washing arrangement of the recirculating aquaculture system further comprises a washing chamber inlet and a washing chamber outlet configured to allow an inlet of freshly supplied wash water to the washing chamber and an outlet of used wash water. Preferably, the washing chamber outlet is fluidly connected to the mixing chamber. When the aquaculture feed is washed, feed residues and surface oils may be located in the wash water. By allowing the used wash water to enter the mixing chamber, these feed residues and oils may be used in the manufacturing of new aquaculture feed. Alternatively, the fatty acid component and feed residues may be filtered from the used wash water, and disposed, whereas the filtered wash water can be reused in the washing chamber or used for manufacturing feed. In the latter case, fresh tap water may then be used as fresh water for the wash water.

In a preferred embodiment, the feed manufacturing system further comprises a gas adding arrangement, said gas adding arrangement being located adjacent the mixing chamber and the shaping arrangement and comprising:
a gas adding chamber having an inlet configured for receiving a feed mixture from the mixing chamber, and an outlet for providing a flow of feed mixture comprising air to the shaping arrangement, and
a gas adding means configured for adding gas into the aquaculture feed.

The gas adding means may e.g. be a rotating whisk or an air ejector which sucks gas into a mixer with an overpressure, where after the mixer kneads or mixes the gas into aquaculture feed.

In another aspect, the invention relates to the use of an aquaculture feed as previously described in a recirculating aquaculture system.

Any embodiment of the invention may be used in any aspect of the invention, and any advantage for a specific embodiment applies equally when an embodiment is used in a specific aspect.

### BRIEF DESCRIPTION OF THE DRAWINGS

FIG. 1 shows the gelling temperature for 1% solutions of kappa carrageenan as a function of added salt type and concentration;

FIG. 2 shows the gelling temperature for 1% solutions of iota carrageenan as a function of added salt type and concentration.

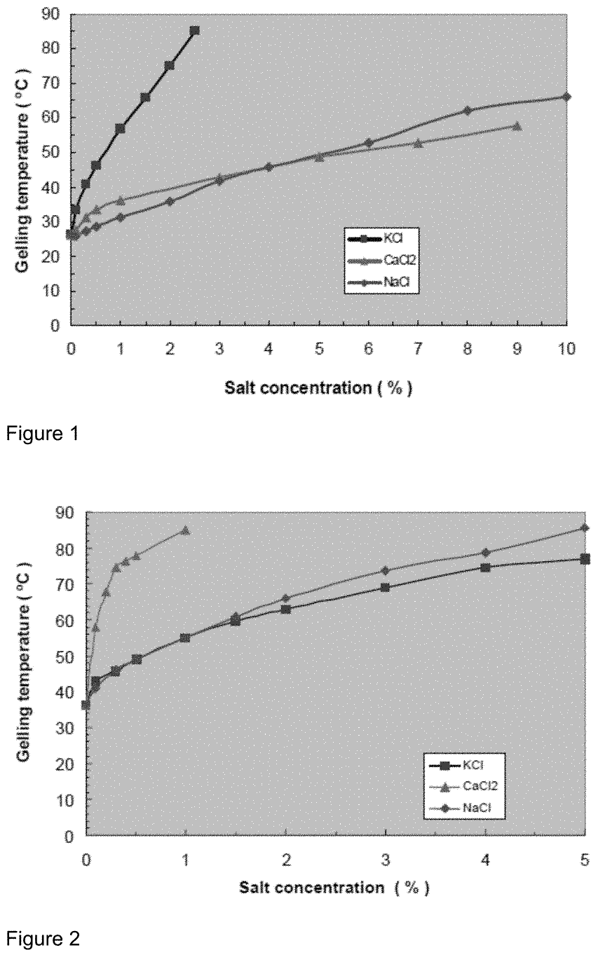

### DETAILED DESCRIPTION

### Example 1

Four experimental types of fish feed, B, D, C, E were manufactured, and a commercially available fish feed for the aquaculture market was acquired from Biomar (OrbitCPK40). Feed type B and D were produced under conditions mimicking known methods for industrial production of salmon feed, i.e. grinding of raw materials, pre-conditioning, hot extrusion, drying, vacuum coating, and cooling, whereas feed type C and E are embodiments of the present disclosure.

The four experimental types of fish feed were manufactured with the purpose of testing the digestibility of fish feed with different levels of moisture, the B and D feed being dry fish feeds and the C and E feeds being moist fish feeds. Further, the feeds were manufactured to investigate the impact of binder concentration (i.e. carrageenan). A major difference in feed composition is thus the moisture content in B and D versus C and E. As the moisture content is more than seven times higher for C/E compared to B/D, the concentrations of the remaining ingredients are relatively lower. However, the dry matter ratios in C and E are aimed to correspond to B and D, respectively. The main difference in dry matter composition in B/C and D/E is the content of carrageenan. In the dry feeds, starch (in this case originating from the wheat) is required to extrude a stable and strong pellet. However, starch is not required for the moist feed of the type described in the present invention. Conversely, carrageenan is not required to produce the extruded dry pellets but allows shaping of the moist feed. Even though wheat is required in B/D and carrageenan is advantageous in C/E, they are partially included in both types of feed. The reason for doing so is to reduce the potential impact on the microbiota of the fish. However, to take advantage of the reduced starch requirement in the recipe for moist feed, C and E have low wheat inclusions and, consequently, relatively higher dry matter concentrations of protein and fat. The commercial control feed OrbitCPK40 is included as a reference for comparing the digestibility of an industrially optimized feed recipe to embodiments of the present disclosure.

The composition of each feed is presented in the below Table 1.

TABLE 1
Feed recipes

| | Dry fish feed | | Moist fish feed of | | Commercial control |
|---|---|---|---|---|---|
| | (prior art) | | the invention | | (dry fish feed) |
| Ingredient | B | D | C | E | OrbitCPK40 |
| Fish meal [%] | 32.1 | 31.3 | 16.0 | 15.5 | — |
| Caseinate [%] | 19.7 | 19.2 | 9.78 | 9.55 | — |
| Carrageenan [%] | 1.84 | 3.88 | 0.910 | 1.83 | — |
| Fish oil [%] | 21.8 | 21.3 | 10.8 | 10.6 | — |
| Wheat [%] | 14.7 | 14.7 | 1.60 | 1.60 | — |
| Premix [%] | 1.84 | 1.84 | 0.910 | 0.910 | — |
| Water [%] | 8.00 | 8.00 | 60.0 | 60.0 | — |

The five feed types B, D, C, E, and OrbitCPK40 were respectively fed to five salmon batches, each batch consisting of 45 salmons (approximate initial unit weight: 40 g), equally distributed in three separate tanks. In total 15 tanks containing 225 salmons. Results from the digestibility study are presented below in Table 2.

TABLE 2
Digestibility of individual classes of nutrients for test feeds as
well as commercial reference

| | | | | | Com- mercial |
|---|---|---|---|---|---|
| | Dry fish feed | | Moist fish feed of the | | control (dry |
| | (prior art) | | invention | | fish feed) |
| Code | B | D | C | E | OrbitCPK40 |
| Pro- tein [%] | 93.6 ± 0.36^{a} | 93.9 ± 0.61^{a} | 95.0 ± 0.21^{b} | 95.3 ± 0.32^{b} | 93.0 ± 0.28^{a} |
| Fat [%] | 92.7 ± 0.27^{a} | 92.5 ± 1.7^{a} | 97.3 ± 0.29^{c} | 96.4 ± 0.72^{bc} | 96.2 ± 0.27^{b} |
| NFE [%] | 58.5 ± 2.7^{b} | 60.6 ± 3.4^{b} | 61.1 ± 1.6^{b} | 63.6 ± 4.2^{b} | 47.9 ± 0.77^{a} |
| Ash [%] | 30.8 ± 3.4^{a} | 33.0 ± 8.4^{a} | 55.5 ± 4.5^{b} | 52.2 ± 3.7^{b} | 40.5 ± 1.2^{a} |
| DM [%] | 82.5 ± 0.64^{a} | 82.3 ± 2.0^{a} | 90.1 ± 0.39^{b} | 89.1 ± 0.81^{b} | 82.6 ± 0.33^{a} |

The numbers in Table 2 have superscripted letters a, b and/or c. These letters indicate how the numbers are grouped according to statistical significance. Thus, numbers with “a” are not statistically different from each other, numbers with “b” are not statistically different from each other, and numbers with “c” are not statistically different from each other, but numbers with a “b” are statistically significantly different from numbers with an “a” or a “c”, numbers with an “a” are statistically significantly different from numbers with an “b” or a “c”, numbers with a “c” are statistically significantly different from numbers with an “a” or a “b”, and numbers with both a “b” and a “c” are statistically significantly different from numbers with an “a”. The significance is at p<0.05.

### CONCLUSION

The embodiments of the present disclosure, fish feeds C and E, had significantly greater digestibility relative to the commercially available dry fish feed (OrbitCPK40) and the dry fish feeds B and D. Both feeds C and E had approximately 3%-points improved digestibility of protein relative to all other tested feed types. Further, feed type C had 1 to 5%-points improved digestibility of fat relative to the corresponding dry feed types. As such, the present disclosure provides fish feeds with improved digestibility over existing dry fish feeds.

What is claimed is:

1-24. (canceled)

25. A method of manufacturing an aquaculture feed comprising the steps of:
providing water, a fatty acid component, a protein source, and a feed stabiliser having an activation condition and a setting condition represented by a setting component;
contacting the feed stabiliser and/or the protein source with the fatty acid component;
contacting the feed stabiliser with the water at the activation condition;
mixing the feed stabiliser, the fatty acid component, the protein source and the water to provide a suspension;
shaping the suspension into a shaped suspension; and
increasing the concentration of the setting component in the shaped suspension to the setting condition of the feed stabiliser to obtain the aquaculture feed.

26. The method of manufacturing an aquaculture feed according to claim 25, wherein the suspension is a dough.

27. The method of manufacturing an aquaculture feed according to claim 25, wherein the feed stabiliser is a carbohydrate-based feed stabiliser.

28. The method of manufacturing an aquaculture feed according to claim 27, wherein the feed stabiliser is selected from kappa-carrageenan, iota-carrageenan, alginate, pectin, carboxymethyl cellulose (CMC), ethyl cellulose, gums, agar, and their mixtures.

29. The method of manufacturing an aquaculture feed according to claim 25, wherein the concentration of the setting component is increased to a threshold level of the setting component.

30. The method of manufacturing an aquaculture feed according to claim 25, wherein the setting component is contained in the protein source and/or the fatty acid component.

31. The method of manufacturing an aquaculture feed according to claim 25, wherein the setting component is selected from the list consisting of alkaline metal ions, earth alkaline metal ions, transition metal ions, H⁺ and OH⁻, or a combination of these.

32. The method of manufacturing an aquaculture feed according to claim 25, wherein the method is performed at ambient temperature.

33. The method of manufacturing an aquaculture feed according to claim 25, wherein at least one heat-labile additive is added to the suspension at or below an intermediate temperature, which intermediate temperature is in the range of 45° C. to 55° C.

34. The method of manufacturing an aquaculture feed according to claim 33, wherein the heat-labile additive is selected from the list consisting of amino acids, enzymes, colourants, flavourings, vitamins, medicine, organic minerals, bacteria, probiotic bacteria, palatants, peptides, antioxidants, steroids or pre-vitamins, and their mixtures.

35. The method of manufacturing an aquaculture feed according to claim 25, wherein the feed stabiliser is dissolved in water at the activation condition prior to mixing the feed stabiliser, the fatty acid component, and the protein source to provide the suspension.

36. The method of manufacturing an aquaculture feed according to claim 25, wherein the shaped suspension is formed into droplets, which droplets are allowed to fall into a liquid at the setting condition.

37. The method of manufacturing an aquaculture feed according to claim 25, wherein no starch is used in the method.

38. The method of manufacturing an aquaculture feed according to claim 26 further comprising the step of adding gas to the dough.

39. The method of manufacturing an aquaculture feed according to claim 38, wherein the gas is selected from the group consisting of nitrogen (N₂), CO₂, O₂ and N₂O, and combinations thereof.

40. The method of manufacturing an aquaculture feed according to claim 26, wherein the step of shaping the dough is performed by passing the dough through a pipe.

41. The method of manufacturing an aquaculture feed according to claim 26 further comprising the step of washing the aquaculture feed to obtain a washed aquaculture feed and a residue portion, said residue portion comprising surface oils and/or loose dough material.

42. The method of manufacturing an aquaculture feed according to claim 41 further comprising the step of separating the aquaculture feed in a first fraction comprising the washed aquaculture feed and a second fraction comprising the residue portion.

43. The method of manufacturing an aquaculture feed according to claim 25, wherein the aquaculture feed is added to a flowing water stream whereby the aquaculture feed is hydraulically transported.

44. The method of manufacturing an aquaculture feed according to claim 26 further comprising the step of drying the dough to a moisture content in the range of 4% w/w to 12% w/w.

45. A feed manufacturing system for producing an aquaculture feed wherein the feed manufacturing system is adapted for being coupled to a recirculation conduit of a recirculating aquaculture system (RAS) and arranged such that the aquaculture feed manufactured in the feed manufacturing system is allowed to enter the recirculation conduit, said feed manufacturing system comprising:
a storage tank for storing an aqueous solution of feed stabiliser having an activation condition and a setting condition represented by a setting component, the storage tank being in fluid communication with a mixing chamber;
the mixing chamber comprising mixing means, the mixing chamber being provided with at least one inlet allowing entry of powder and liquid raw materials into the mixing chamber, the mixing chamber having an outlet allowing a feed mixture to exit the mixing chamber,
a shaping arrangement fluidly connected and located adjacent to the outlet of the mixing chamber, the shaping arrangement comprising a flow channel configured to shape the feed mixture flowing through the flow channel, and the shaping arrangement optionally comprising cooling means for cooling a feed mixture flowing through the flow channel.

46. The feed manufacturing system according to claim 45, which feed manufacturing system does not comprise a heat exchanger.

47. The feed manufacturing system according to claim 45, wherein the feed manufacturing system further comprises a washing arrangement comprising:
a washing chamber being configured to allow entry of an aquaculture feed from the shaping arrangement and for containing a washing liquid,
a liquid driving force for providing movement of the washing liquid to wash the aquaculture feed, and
a transport arrangement configured to remove the aquaculture feed from the washing chamber, draining the washing liquid from the aquaculture feed and delivering the aquaculture feed to the water recirculation conduit.

48. The feed manufacturing system according to claim 45, wherein the feed manufacturing system further comprises a gas adding arrangement, said gas adding arrangement being located adjacent the mixing chamber and the shaping arrangement and comprising:
a gas adding chamber having an inlet configured for receiving a feed mixture from the mixing chamber, and an outlet for providing a flow of feed mixture comprising air to the shaping arrangement, and
a gas adding means configured for adding gas into the aquaculture feed.
